(19) United States
(12) Patent Application Publication
(10) Pub. No.: US 2024/0322297 A1
(43) Pub. Date: Sep. 26, 2024

(54) EXTERNAL BATTERY HOUSING HEATING AND COOLING SYSTEM FOR BATTERY MODULES OF AN ELECTRIC VEHICLE

(71) Applicant: FCA US LLC, Auburn Hills, MI (US)

(72) Inventors: Andrew Cooper, Berkley, MI (US); Paul R. Stibich, Troy, MI (US); Luke T. Douma, Holly, MI (US); Eric E. Lund, Oxford, MI (US)

(21) Appl. No.: 18/186,578

(22) Filed: Mar. 20, 2023

(51) Int. Cl. H01M 10/6568; H01M 10/48; H01M 50/289

(52) U.S. Cl. CPC H01M 10/6568; H01M 10/482; H01M 50/289

(57) ABSTRACT

A battery heating and cooling system for an electric vehicle includes a battery housing having a plurality of walls, said plurality of walls may include a first wall. The system further includes a first battery module including a first plurality of battery cells disposed between the plurality of walls. The first wall may include a first fluid channel disposed therein. The first fluid channel has a fluid inlet and a fluid outlet.

### FIELD

The present disclosure relates to a battery module system and, more particularly, to a heating and cooling system using channels in exterior walls of a battery housing.

### BACKGROUND

This section provides background information related to the present disclosure which is not necessarily prior art.

Electric vehicles rely on battery cells bundled into one or more battery modules to power the vehicle. One or more battery modules are disposed within a battery housing. The battery cells increase the temperature inside the battery module housing during use. At start up, the batteries may need to be warmed to function efficiently. As long as the temperature remains within a tolerable range, the battery cells can continue to operate. To operate efficiently, the temperature across the battery modules should be operated within a very close range.

In order to monitor the status of battery cells and/or a battery module, electric vehicle power systems may include temperature sensors to monitor temperatures associated with the battery modules and/or battery cells. Such systems are typically used to detect runaway conditions in a battery module.

Typically, cooling plates within the battery housing are used for cooling. Heat shields on other heat sources are used to protect the battery housing. Other vehicle components such as the exhaust, engine, catalytic converters, motors employ heat shields to reduce the heat conduction to the battery housing.

### SUMMARY

This section provides a general summary of the disclosure and is not a comprehensive disclosure of its full scope or all its features.

The present disclosure provides a system having externals channels formed into the outer walls of the battery housing. The outer walls are adjacent to the external environment. The present system uses active cooling in the external environment to which the vehicle is exposed. Since battery cases are very heavy they are placed low in the vehicle for better vehicle dynamics, underbody packaging space for all of the necessary vehicle components is at a premium. The present design reduces overall packaging space by using internal cavities and reduces the need for heat shields of the battery housing or heat generating components.

In one aspect of the disclosure, the system includes a battery housing having a plurality of walls, said plurality of walls may include a first wall. The system further includes a first battery module including a first plurality of battery cells disposed between the plurality of walls. The first wall may include a first fluid channel disposed therein. The first fluid channel has a fluid inlet and a fluid outlet.

Other aspects include the system where the first fluid channel is integrally formed with the first wall. The first fluid channel and the second fluid channel are fluidically coupled together with a fitting. The fitting may include a valve associated therewith, said valve controlled in response to a temperature signal from a first temperature sensor within the first battery module. The first wall may include a longitudinal side. The first wall may include an end wall. The first wall may include a top wall. The first wall may include a floor wall. The battery housing may include the first battery module and a second battery module, said first wall adjacent to the first battery module and the second battery module. The battery housing may include the first battery module and a second battery module and where the first wall may include an intermediate wall disposed between the first battery module and the second battery module. The battery housing may include a second wall fluidically coupled to the first wall. The first fluid channel is cylindrical in shape. The first fluid channel is rectangular in shape. The system further an inlet module pump; an inlet valve in fluid communication with the inlet module pump communicating fluid into the fluid channel within the first wall of the plurality of walls; an outlet valve in fluid communication with the outlet; a temperature sensor generating a temperature signal indicative of the temperature within the first battery module; and a controller coupled to the inlet module pump, the inlet valve and the outlet valve, said controller controlling a flow rate into the fluid channel based on the temperature signal. The controller controls the valves based on the temperature signal. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method of controlling a battery module having a plurality of walls. The method also includes communicating fluid within the first fluid channel within the first wall. The method also includes controlling a temperature within the battery module by controlling a flow rate through the battery module by controlling an inlet module pump.

Implementations may include one or more of the following features. The method may include communicating the fluid to the battery module through an inlet valve. The method may include communicating the fluid from the battery module through an outlet valve. The method may include communicating fluid to a second fluid channel within a second wall of the plurality of walls. The method may include controlling a valve between the first fluid channel and the second fluid channel based on the temperature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of a high voltage battery within a vehicle.

FIG. 2A is an example of a battery housing within the high voltage battery of FIG. 1 as controlled by the battery conditioning system and the battery management system.

FIG. 2B is a second example of a battery housing within the high voltage battery of FIG. 1 as controlled by the battery conditioning system and the battery management system.

FIG. 2C is a top view of an intersection weld at a longitudinal side and an end wall.

FIG. 2D is a third example of a battery housing controlled by the battery conditioning system.

FIG. 2E is a fourth example of a battery housing.

FIG. 3A is a perspective exploded view of a battery housing and cover wall.

FIG. 3B is a perspective view of a cover wall or floor wall having fluid channels therein.

FIG. 4A is a cross sectional view of a side of the battery housing and a fluid circuit.

FIG. 4B is a front view of an end cap of a housing.

FIG. 4C is an alternate cross sectional view of a side of the battery housing.

FIG. 4D is a third example of a cross section of a housing.

FIG. 5A is a schematic view of the fluid distribution system of the battery housing 26.

FIG. 5B is an enlarged view of a corner of a battery housing.

FIG. 5C is an enlarged view of a fluidic coupling or the ends of sides such as longitudinal sides 32.

FIG. 5D is a fluidic diagram of walls representing longitudinal walls or end walls having a T-fitting disposed therebetween.

FIG. 5E is an enlarged view of an angle fitting.

FIG. 5F is an enlarged view of a T-fitting.

FIG. 5G is an enlarged view of an in line fitting.

FIG. 6 is a flowchart of a method for operating the system.

Corresponding reference numerals indicate corresponding parts throughout the several views of the drawings.

### DETAILED DESCRIPTION

Example embodiments will now be described more fully with reference to the accompanying drawings.

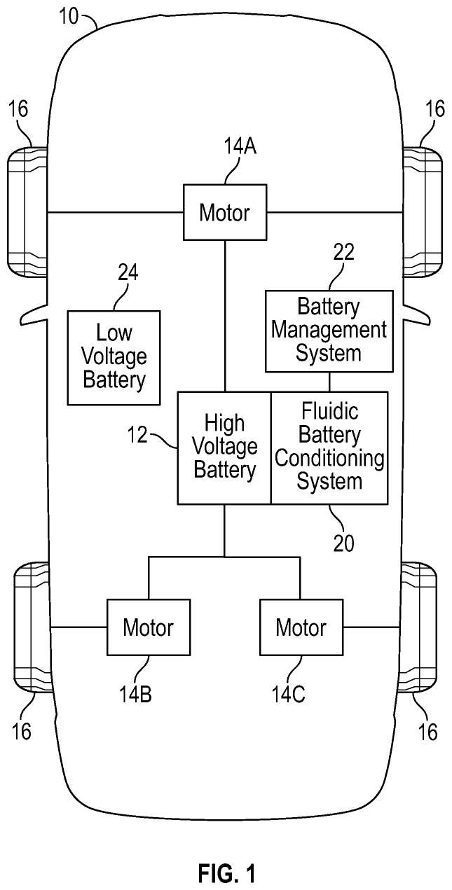

Referring now to FIG. 1, a schematic block diagram of a vehicle 10 is illustrated. The vehicle 10 is adapted to include various features not illustrated such as a passenger compartment mounted thereon.

The vehicle 10 is an electric vehicle that has a high voltage battery 12 that is used to power one or more electric motors 14A, 14B and 14C. The electric motors 14A, 14C, 14C are used to provide motive force to the vehicle wheels 16. The number of motors within an electric vehicle may vary. Each of the wheels 16 may have their own motor associated therewith. As shown in the rear of the vehicle 10, each wheel has an electric motor 14B, 14C. One motor 14A is used to power the wheels at one end of the vehicle. The motors 14B and 14C power individual wheels 16.

A fluidic battery conditioning system 20 is used for controlling the temperature and pressure within the high voltage battery 12. A battery management system 22, in communication with the fluidic battery conditioning system and any sensors associated with the high voltage battery, is used to control the operation of the fluidic battery conditioning system 20 as described in more detail below. The battery management system 22 is a microprocessor-based controller programmed to perform various steps in the operation of the system.

The vehicle 10 also includes a low voltage battery 24 that has a voltage less than the high voltage battery 12. Examples for the low voltage battery 24 include but are not limited to a 12 volt or 48 volt battery. An example of a high voltage battery 12 is 400 volts plus or minus 50 volts.

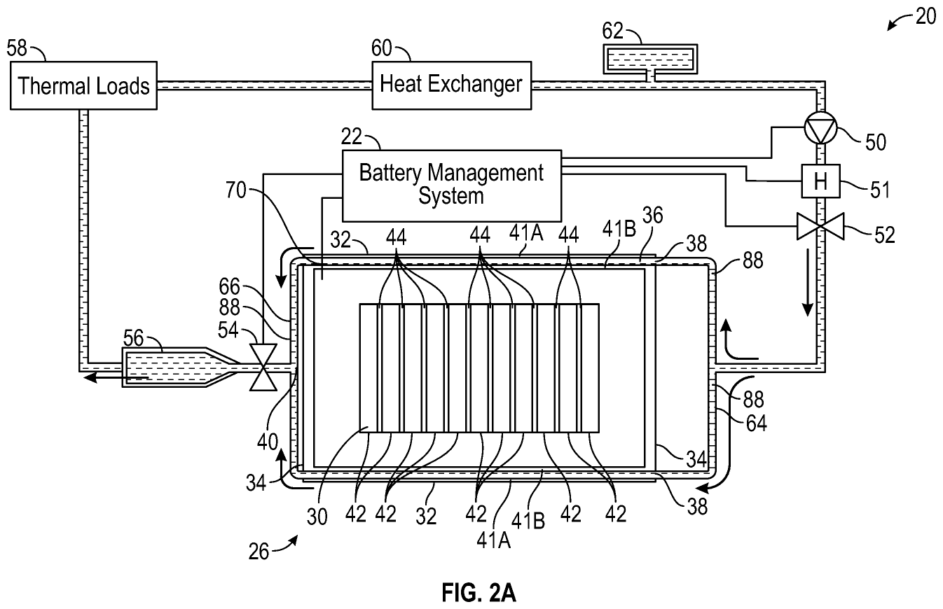

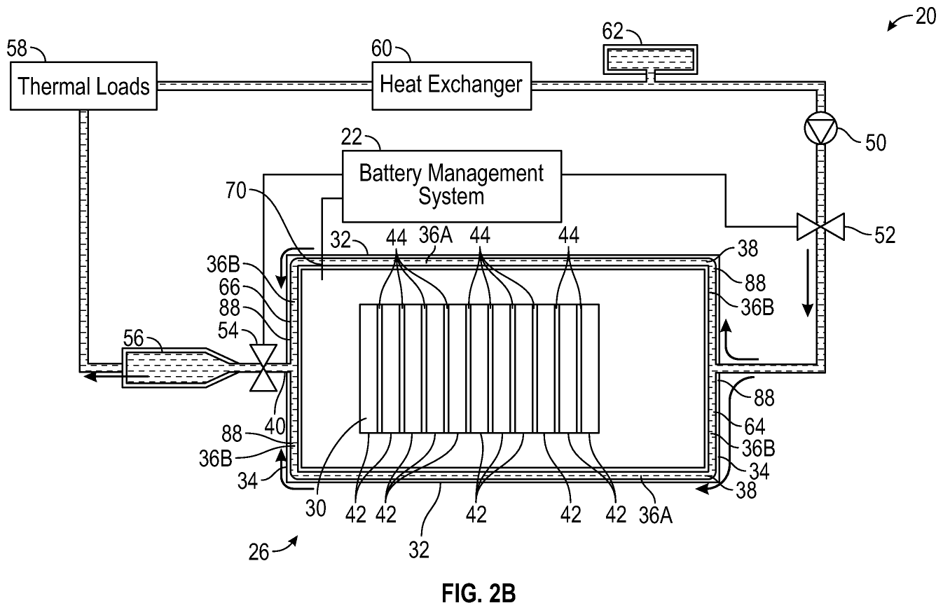

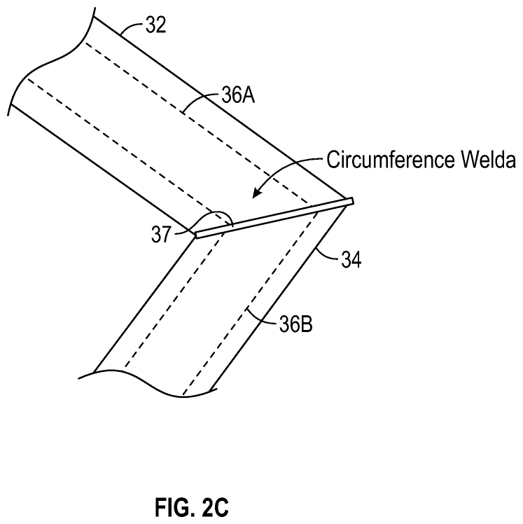

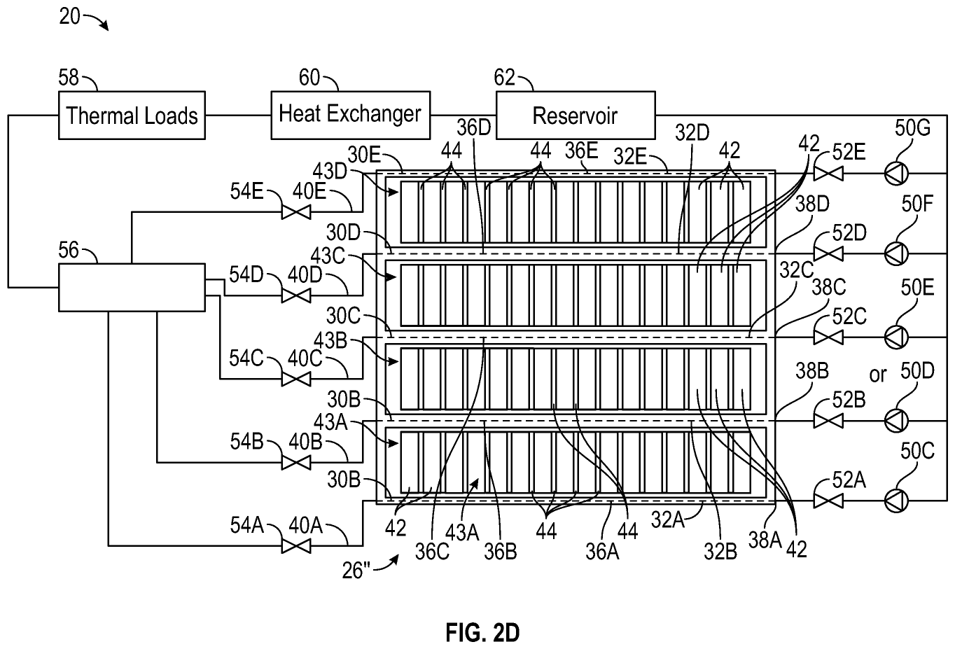

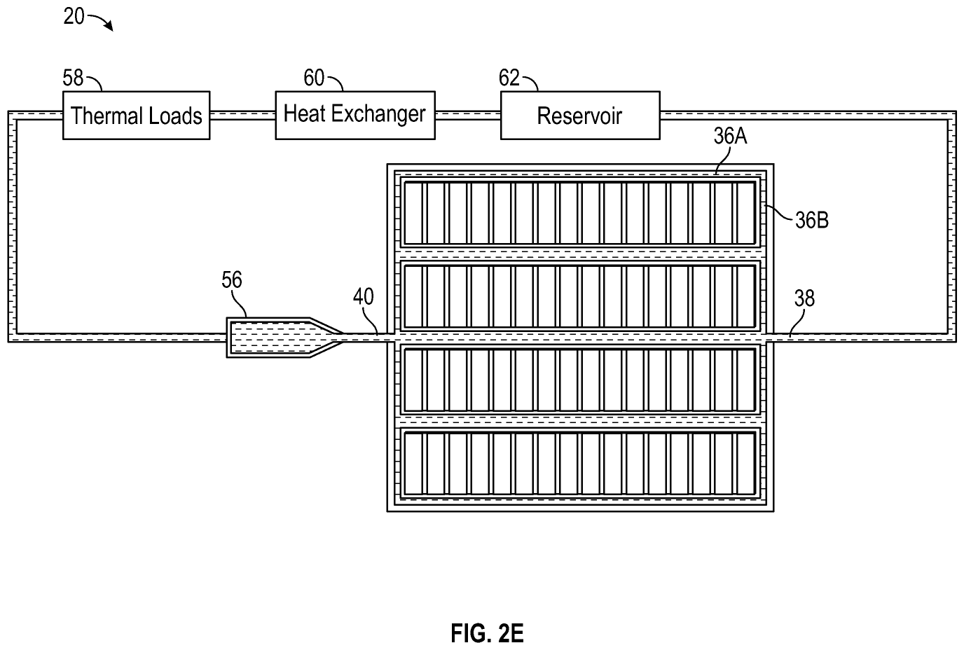

Referring now to FIG. 2A, a battery housing 26 having a battery module 30 representing one battery module of a plurality of battery modules 30 provided within the high voltage battery 12 is illustrated in FIG. 1. Different configurations for different configurations of battery housings are provided. Different vehicle requirements for the number of battery cells and packaging limitations will require variations. The battery housing 26, in this example, is formed from longitudinal sides 32, which in this example are parallel. End walls 34 are parallel and are coupled to the longitudinal sides 32 perpendicularly. In the present example, the longitudinal sides 32 and the end walls 34 (and a cover wall and floor wall, not shown) form a rectangular solid that forms the housing 26.

At least one of the longitudinal sides 32, the end walls 34, the cover wall or the floor wall of the housing 26 have a fluid channel 36 with a fluid inlet 38 and a fluid outlet 40 so that fluid is passed into and out of the longitudinal sides 32 of the housing 26 to controllably cool or heat the battery module 30. In this example, the longitudinal walls 32 have the inlet 38 and the outlet 40. In the present example the fluid channel 36 is integrally formed a hollow portion or passage within the longitudinal sides 32. The longitudinal sides 32 in one example are extruded and have an outer wall 41A and an inner wall 41B between which the fluid channel 36 is disposed. As described in further detail below, various cross-sectional shapes in different examples are employed by the longitudinal sides 32 and the fluid channels 36 therein.

A plurality of battery cells 42 are disposed within the housing 26. The battery cells 42, in this example, are parallel to the end walls 34 and perpendicular to the longitudinal walls 32. Of course, other configurations are available. Spacers 44 are disposed between the battery cells 42. The spacers 44 are formed of foam in this example. The spacers 44 are therefore compressible. For some battery technologies, the spacers 44 are optional.

The fluidic battery conditioning system 20 of FIG. 1 includes an inlet module pump 50 that communicates the fluid into the inlets 38 through the fluid channels 36 of the housing 26. The inlet module pump 50, in this example, is a constant flow rate pump. The pump 50 is a centrifugal pump. The inlet module pump 50 is used to control the temperature within the battery module 30 as described in further detail below.

A heater 51 is be disposed in this example of the fluidic circuit. The heater 51 is used to keep the battery cells 42 warm for initial cold operation. The pump 50 circulates warm fluid into the battery housing 26. This is useful in colder climates and used until the battery cells 42 generate enough heat themselves. The BMS 22 controls the heater 51 in response to the temperature of the battery module. The heater 51 can also be incorporated into the examples below.

An inlet valve 52 allows control of the fluid in the fluid channels 36 of the battery housing 26. That is, the inlet valve 52 is controlled by the battery management system 22 so that the temperature within the housing 26 is controlled as will be described in further detail below.

After the fluid is communicated through the fluid channels 36 and the housing 26, the outlet 40 communicates fluid though an outlet valve 54. Together with the inlet valve 52 the outlet valve 54 are used to control the temperature within the housing 26. The outlet valve 54 may be referred to as a backflow valve.

After the outlet valve 54, the fluid is fluidically communicated to an expansion element 56 and ultimately to the other elements of the fluidic battery conditioning system. The expansion element 56 may be an expansion line or an orifice. The expansion element 56 is used to expand the fluid and therefore reduce the fluid pressure before being communicated to the cooling components.

After the expansion element 56, fluid is fluidically communicated to other thermal loads 58 and the heat exchanger 60 to cool the fluid before the heat exchanger 60 communicates the fluid to a reservoir 62 and to the inlet module pump 50. The thermal loads 58 and the reservoir 62 are optional features.

Between the inlet valve 52 and the inlets 38 is an inlet manifold 64. The shape and layout of inlet manifold 64 will vary depending on the layout of the fluid channels 36. Likewise, an outlet manifold 66 is fluidically coupled between the outlet 40 and the outlet valve 54. Again, the shape and layout of outlet manifold 66 will vary depending on the layout of the fluid channels 36. In the example of FIG. 2A. Two pipes 88 or conduits form each manifold 64, 66.

A temperature sensor 70 generates a temperature signal that corresponds to the temperature of the fluid within the battery housing 26. The temperature sensor 70 thus provides data that corresponds to the temperature of the battery cells 42 within a battery module. The battery management system 22 increases or decreases the speed of the pump 50 (or changes the settings on valves) and correspondingly the flow rate and direction of flow in the fluid channels 36 based upon the temperature as determined from the temperature signal of the temperature sensor 70. The pump 50 is used to control the flow rate through the housing 26. The valves as described later change the direction or enable flow through selected fluid channels 36.

Although only one battery module 30 is illustrated, a number of battery modules are provided in a battery housing 26 of a vehicle system that are configured in a similar way in examples below.

Referring now to FIGS. 2B and 2C, another example of a battery housing 26′ is illustrated. In this example, the battery housing 26′ has longitudinal sides 32 having the fluid channels 36A disposed therein. The end walls 34 have fluid channels 36D disposed therein. The fluid inlets 38 are fluidically coupled to the fluid channels 36B which, in turn, communicate fluid to the fluid channels 36A towards the outlet 40. The fluid channels 36B communicate fluid from the fluid channels 36A to the outlet 40. In this manner, more surface area of the walls communicate fluid to the battery module 30.

FIG. 2C specifically shows that a circumferential weld 37 may be used to join the longitudinal sides 32 and the end walls 34 as well as the fluid channels 36A, 36B.

Referring now to FIG. 2D, another example of a battery housing 26″ is set forth. The housing 26″ includes a plurality of battery modules 30A, 30B, 30C, 30D that are positioned adjacent to each other. Some of the battery modules 30A-D may include some common intermediate longitudinal sides walls 32B-D in addition to the outside longitudinal walls 32A, 32E. Each of the longitudinal walls 32A-E include respective inlets 38A-E and outlets 40A-E. Each of the longitudinal walls 32A-32E include respective fluid channels. Each of the battery modules 30A-D include respective battery stacks 43A-43D as described above.

The battery housing 26″ has a fluidic battery conditioning system as described in FIGS. 2A and 2B. Each of the battery modules 30A-D includes an outlet valve 54A-54D respectively. However, common elements such as the expansion element 56, the thermal loads 58, the heat exchanger 60, and the reservoir 62 are shared by the battery modules 30A-30D. Each of the longitudinal walls 32A-32E include respective inlet module pumps 50A-50D. In this manner, more precision in the control of the temperature within the battery modules 30A-30D is achieved.

Referring now to FIG. 2D, another example of high voltage battery housing 26′″ with battery modules 30A-E is set forth. In this example, the end walls have a continuous fluid channel as illustrated in a similar manner in FIG. 2B. Fluid flows into the inlet 38 and is communicated through the end walls 34.

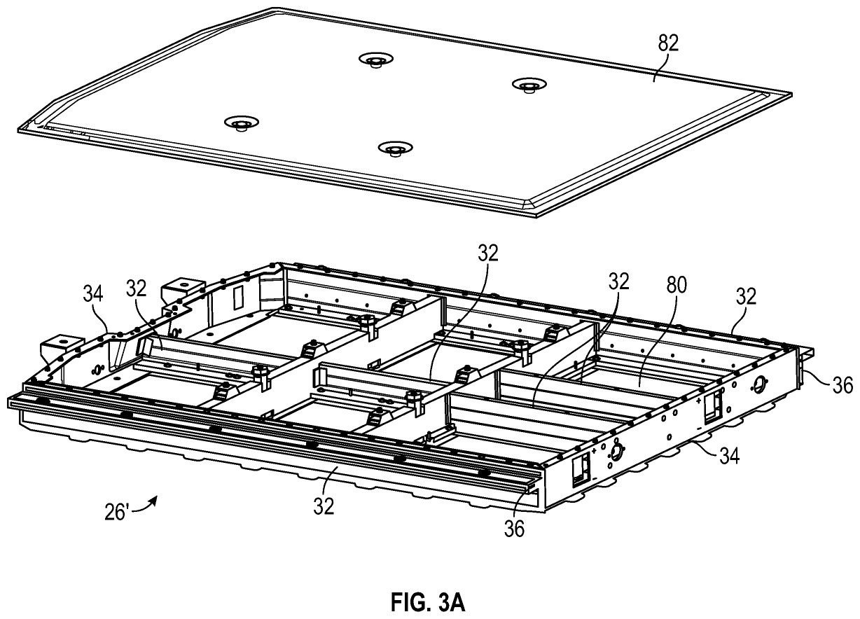

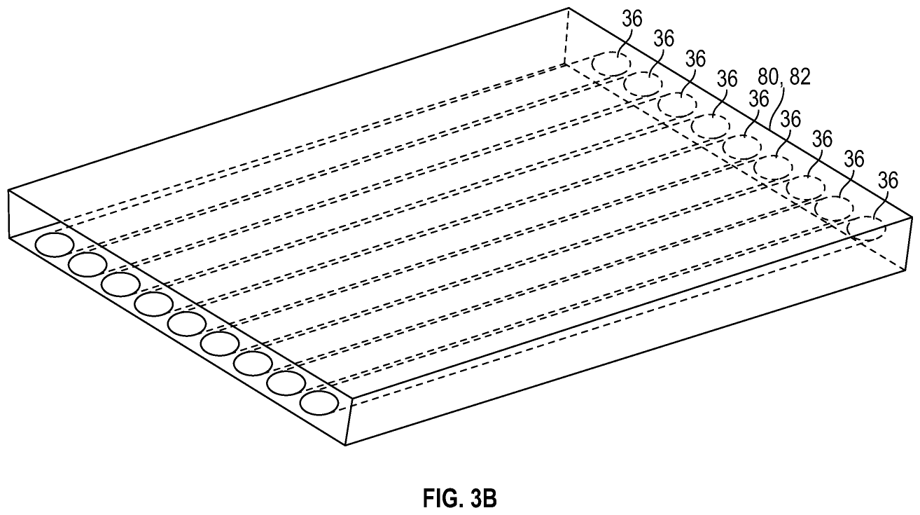

Referring now to FIG. 3A, a battery housing 26iv is set forth. In this example, a plurality of longitudinal sides 32 and end walls 34 are set forth. In addition, a floor wall 80 and a cover wall 82 are also set forth. The floor wall 80 and cover wall 82 may also include fluid channels 36 disposed therein. Likewise, all or some of the longitudinal sides 32 and end walls 34 may have fluid channels 36 disposed therein.

Referring now to FIG. 3B, a perspective view of the floor wall 80 or the cover wall 82 is set forth. As mentioned above, a plurality of fluid channels 36 may extend therethrough. In this example, the fluid channels 36 extend longitudinally through the cover wall 82 or floor wall 80. The floor wall 80 and the cover wall 82 may be formed in a similar manner and therefore are illustrated together in FIG. 3B.

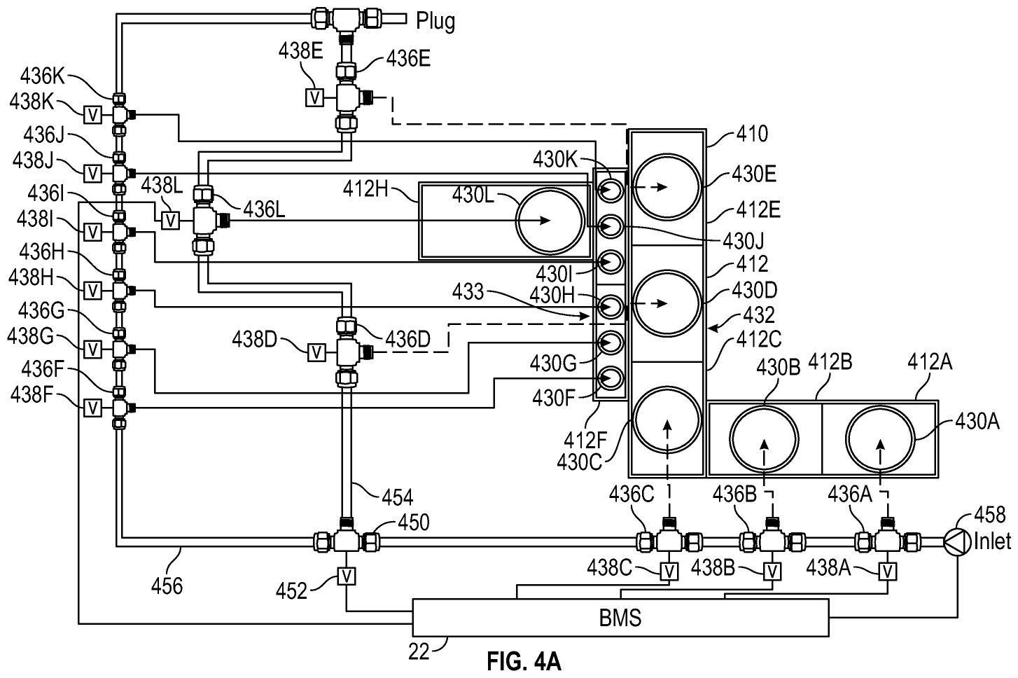

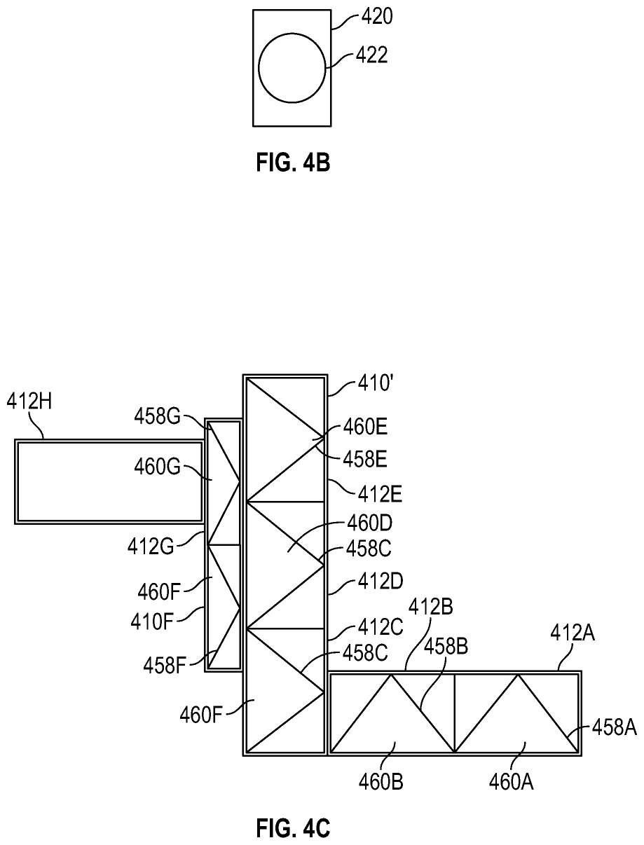

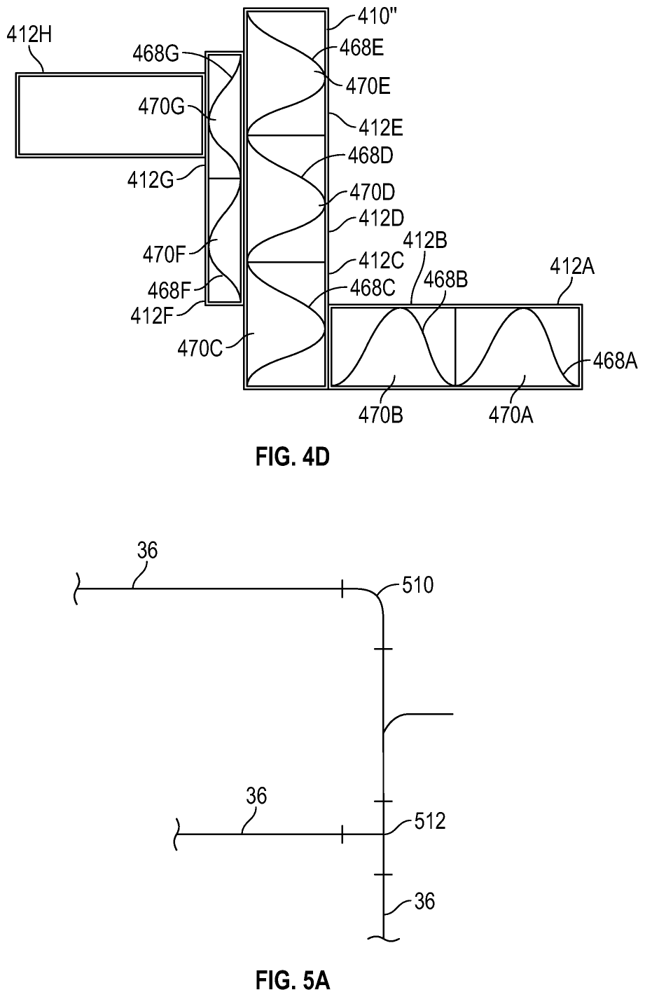

Referring now to FIG. 4A, a cross section of a wall 410 is illustrated. The cross section of the wall may correspond to one of the longitudinal sides 32 or the end wall 34. In this example, an extrudable cross section is illustrated having a plurality of rectangular portions 412A-412H. The rectangular portions 412A may be used alone and fitted with fittings described below to allow fluid to pass therethrough. For example, in FIG. 4B, a fluid plate 420 is illustrated having a circular opening 422 to allow receiving a fitting. Although the fluid plate 420 is illustrated for one of the sections, an enlarged fluid plate may be formed in the overall shape of the exclusion with a plurality of openings 422 disposed therein.

Referring back to FIG. 4A, the fluid channels 36, in this example, may include cylindrical channels 430A-430L that have an inner wall 432 and an outer wall 433. The cylindrical fluid channel 430A is located in the rectangular portion 412A. Fluid channel 430B is located in rectangular portion 412B. Rectangular channel 412C has the cylindrical fluid channel 430C disposed therein. Rectangular portion 412D has rectangular portion 430D disposed therein. Rectangular portion 412E has rectangular portion 430E disposed therein. Rectangular portion 412F has fluid channels 430F, 430G and 430H disposed therein. Rectangular portion 412G has cylindrical fluid channels 430I, 430J, 430K disposed therein. Rectangular portion 412H has cylindrical fluid channel 430L disposed therein. The fluid channels may use the entire cross-sections of the rectangular portions 4412A-412H without the cylindrical fluid channels 430A-430L The cylindrical fluid channels 430A-430L have a width that generally corresponds to the narrowest dimension of the rectangular portions 412A, 412H, respectively.

The cylindrical fluid channels 430A-430L may be threaded to receive various fittings as described below. In FIG. 4A, a plurality of T-fittings 436A-436E correspond to the cylindrical fluid channels 430A-430E. The T-fittings 436A-436E may have valves 438A-438E associated therewith. The valves 438A-438E may be controlled to operate based upon the temperatures within the battery modules within the battery housing using the battery management system 22 for control thereof.

The cylindrical fluid channel 430L may also have a T-fitting 436L and a valve 438L associated therewith. T-fittings 436F-436K are associated respectively with the cylindrical fluid channels 430F-430K. Each of the fittings may also have a valve 438F-438K associated therewith that are coupled to the battery management system 22 for control. Of course, some or all of the valves may or may not have individual control valves 438 associated therewith.

In the example, a valve 452 controls the fluid channels to the valves 436D-436L and 436E as well as to the fittings 436F-436J. The valve 452 may allow fluid passage to the branch 454 or the branch 456. Of course, the fitting 450 may remain in an open state and be controlled by an inlet valve 458. A cross section of a wall 410 similar to that set forth above is provided. In this example, the rectangular portions 412A-412H are provided. However, the fluid channels 460A-460G may be used for communicating fluid therethrough. In this example, the fluid channels 460A-460G are triangular in shape. Of course, the entire rectangular portions may be used to communicate fluid therethrough.

Referring now to FIG. 4D, the same rectangular portions 412A-412H are illustrated in the wall 410″. In this example, the wall 468A-468G are sine shaped and define a partial curved fluid path for 470A-470G.

In FIGS. 4C and 4D, fittings may be incorporated to fit to define the fluid paths 460, 470.

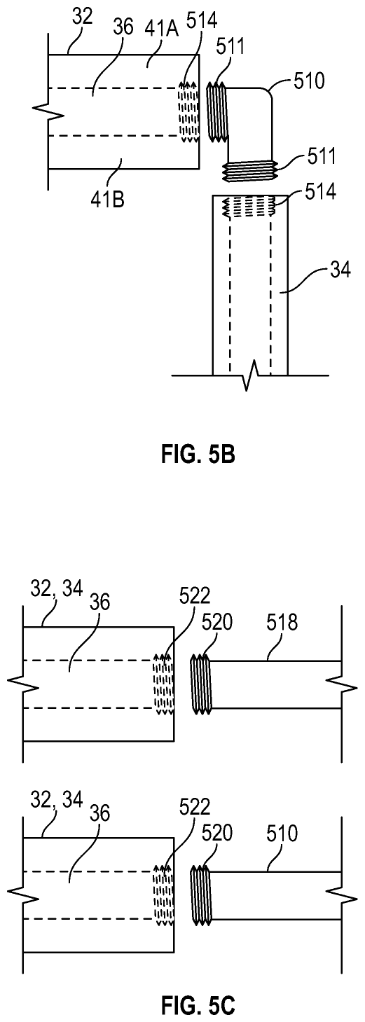

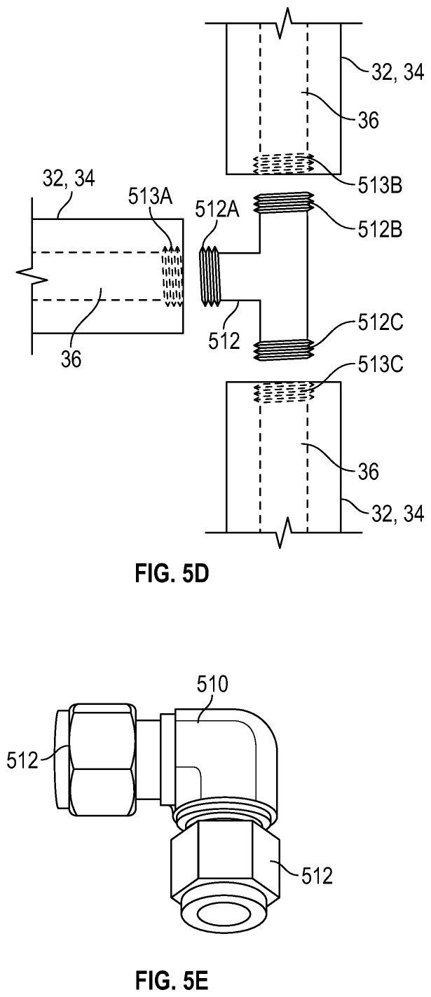

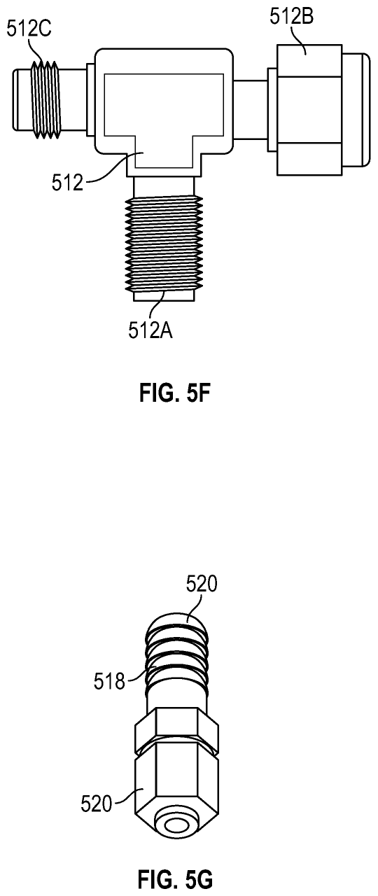

Referring now to FIG. 5A, welding was mentioned above in FIG. 2C for coupling adjacent walls together. In FIG. 5A, fluid paths 36 are coupled together with fittings such as a corner fitting 510 and a T-fitting 512. The fluid paths 36 correspond to the fluid paths in adjacent walls. In this manner, the extrusions may be used while fittings 510, 512 are placed within the fluid paths 36 to fluidically couple the fluid paths together.

In FIG. 5B, a corner fitting 510 is illustrated adjacent to two fluid paths 36 within a longitudinal wall 32 and an end wall 34. Exterior threads 512A may be used to couple to interior threads 514.

Referring now to FIG. 5C, fittings 518 may have exterior threads 520 that couple to interior threads 522 within fluid channels 36. The fittings 518 may be used to join to a manifold, a cover wall or a floor wall.

Referring now to FIG. 5D, an example of a corner fitting 510 is illustrated. Threads 511 may be provided therein.

Referring now to FIG. 5E is a schematic view of a T-fittings having threads 512A that join with threads 513A of a fluid channel 36, threads 513B of a fluid channel 36 that join with threads 512B of the T-fitting 512 and threads 512C that join with threads 513C of the fluid channel 36.

Referring now to FIG. 5F, a T-fitting 512 is illustrated having threads 512A, 512B and 512C thereon.

Referring now to FIG. 5G, the inline fitting 518 is illustrated. Threads 520 are disposed thereon. In all of the above configurations, the threads may be internal or external depending on the desired geometry.

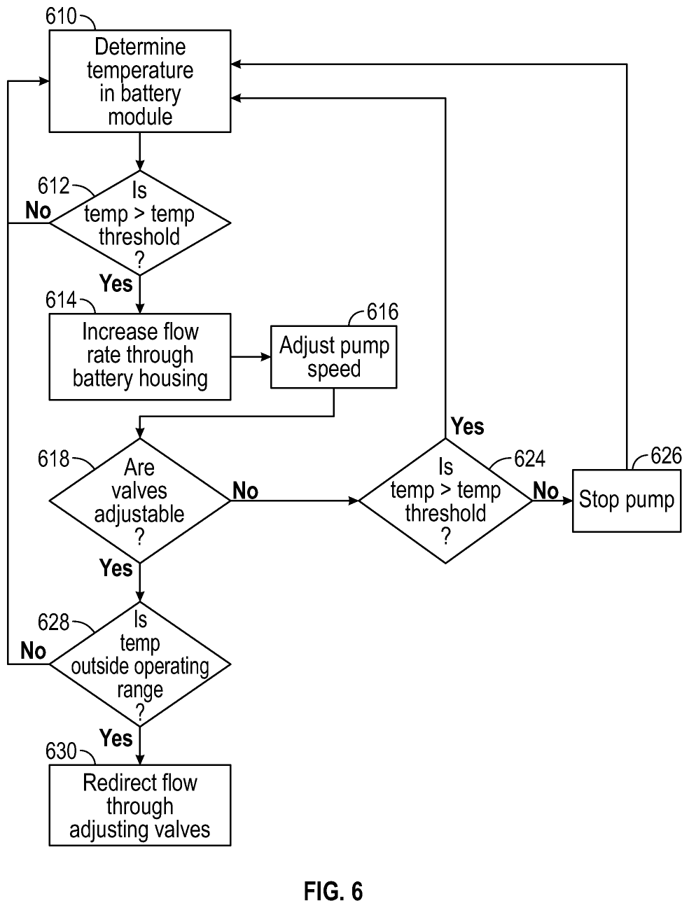

Referring now to FIG. 6, a method for operating the system is set forth. In step 610, the temperature in the battery module is determined based upon the temperature sensor 70 illustrated in FIGS. 2A, 2B. If more than one module is used, multiple temperatures may be determined in one or more of the battery modules. The temperature signals from one or more temperature sensors 70 is communicated to the battery management system 22 that determines the temperature within each of the battery modules. If the temperature in one or more of the battery modules is greater than a temperature threshold in step 612, step 614 controls the increase in the flow rate through the battery housing in step 614 by adjusting the speed of the inlet module pump 50 (or pumps 50C-F) in step 616.

After step 616, step 618 is performed in which it is determined if valves are adjustable. If the valves are not adjustable in step 618, step 624 determines whether the temperature is above a temperature threshold, if yes the system repeats at step 610. In step 624, when the temp is not above the temperature threshold, step 626 is performed to stop the pump. Thereafter step 610 is performed.

In step 618 when there are valves to be controlled, step 628 determines whether the temperature of any modules is outside an operating range. This may be performed using two thresholds, a low temperature threshold and a high temp threshold. Various valves such as inlet valves, or valves associated with various fittings may be controlled. If the temperature determined by the battery management system 22 from the temperature sensors 70 (of FIG. 2A) indicates that the temperature of one or more of the battery cells is outside of a temperature range, step 630 increases or decreases the flow to or around a battery module by controlling the valves. That is, valves may be opened or closed if the temperature is below a low temperature threshold or opened if the temperature of a battery module is above the high temperature threshold. Controlling the valves allows flow through selected fluid channels depending on the temperatures within the battery modules to control the temperatures within the to be within a desirable range of operation. Ultimately the valves are controlled by the battery management system 22 in response to the feedback from the temperature sensor or sensors 70.

After step 618 indicates that there are adjustable valves and the temperature is outside the pressure range, step 620 redirects flow around the battery modules by controlling the valves. If the temperature is greater than a temperature threshold, for example, more valves are opened and flow from the pump increased. If the temperature is below a lower temperature threshold, the inlet valves, the outlet valves or other valves are closed to prevent further cooling or heating.

Thus, the feedback from the battery management system 22 can independently increase or decrease the temperature by adjusting the flow of fluid in and around the battery module by controlling pump speed and enabling or disabling flow through selected fluid channel by controlling valves . . . .

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system comprising:
a battery housing having a plurality of walls, said plurality of walls comprising a first wall;
a first battery module comprising a first plurality of battery cells disposed between the plurality of walls;
said first wall comprising a first fluid channel disposed therein; and
said first fluid channel having a fluid inlet and a fluid outlet.

2. The system of claim 1 wherein the first fluid channel is integrally formed with the first wall.

3. The system of claim 2 further comprising a second wall comprising a second fluid channel disposed therein, wherein the first fluid channel and the second fluid channel are fluidically coupled together with a fitting.

4. The system of claim 3 wherein the fitting comprises a valve associated therewith, said valve controlled in response to a temperature signal from a first temperature sensor within the first battery module.

5. The system of claim 1 wherein the first wall comprises a longitudinal side.

6. The system of claim 1 wherein the first wall comprises an end wall.

7. The system of claim 1 wherein the first wall comprises a top wall.

8. The system of claim 1 wherein the first wall comprises a floor wall.

9. The system of claim 1 wherein the battery housing comprises the first battery module and a second battery module, said first wall adjacent to the first battery module and the second battery module.

10. The system of claim 1 wherein the battery housing comprises the first battery module and a second battery module and wherein the first wall comprises an intermediate wall disposed between the first battery module and the second battery module.

11. The system of claim 10 wherein the battery housing comprises a second wall fluidically coupled to the first wall.

12. The system of claim 1 wherein the first fluid channel is cylindrical in shape.

13. The system of claim 1 wherein the first fluid channel is rectangular in shape.

14. The system of claim 1 wherein the system further an inlet module pump;
an inlet valve in fluid communication with the inlet module pump communicating fluid into the fluid channel within the first wall of the plurality of walls;
an outlet valve in fluid communication with the outlet;
a temperature sensor generating a temperature signal indicative of the temperature within the first battery module; and
a controller coupled to the inlet module pump, the inlet valve and the outlet valve, said controller controlling a flow rate into the fluid channel based on the temperature signal.

15. The system of claim 14 further comprising a plurality of valves associated with a plurality of fluid passage and wherein the controller controls the valves based on the temperature signal.

16. A method of controlling a battery module having a plurality of walls, at least one of the plurality of walls comprising a first fluid channel disposed therein, said battery module comprising a plurality of battery cells disposed between the plurality of walls, said method comprising
communicating fluid within the first fluid channel within the first wall; and
controlling a temperature within the battery module by controlling a flow rate through the battery module by controlling an inlet module pump.

17. The method of claim 16 further comprising communicating the fluid to the battery module through an inlet valve.

18. The method of claim 16 further comprising communicating the fluid from the battery module through an outlet valve.

19. The method of claim 16 wherein further comprising communicating fluid to a second fluid channel within a second wall of the plurality of walls.

20. The method of claim 19 further comprising controlling a valve between the first fluid channel and the second fluid channel based on the temperature.
